(19) United States
(12) Patent Application Publication
(10) Pub. No.: US 2004/0009107 A1
(43) Pub. Date: Jan. 15, 2004

(54) Aircraft evacuation slide inflator using a catalytically decomposed gas

(75) Inventor: James J. Baker, Waldorf, MD (US)

Correspondence Address: John D. Titus, The Cavanagh Law Firm, Ste. 2400, 1850 N. Central Avenue, Phoenix, AZ, 85004, US

(73) Assignee: UNIVERSAL PROPULSION COMPANY, INC., Phoenix, AZ (US)

(21) Appl. No.: 10/194,026

(22) Filed: Jul. 12, 2002

(51) Int. Cl. B01J 3/00

(52) U.S. Cl. 422/242; 422/198

(57) ABSTRACT

An inflation device for an aircraft emergency evacuation slide or other inflatable device produces a greater number of moles of gas than the number of moles of gas stored. This is accomplished by selecting the stored inflation gas to be one of a family of gases capable of undergoing a thermal decomposition, such as nitrous oxide, such that two moles of nitrous oxide are decomposed to form two moles of diatomic nitrogen and a mole of diatomic oxygen. Because the universal gas constant is the same for all gases, the three moles of nitrogen and oxygen produced by the decomposition of two moles of nitrous oxide occupy 50% more volume than the two moles of nitrous oxide would have occupied at the same temperature and pressure. By decomposing the stored nitrous oxide, the inflator is capable of inflating a device that is 50% larger than would be possible using un-decomposed gas.

### BACKGROUND OF THE INVENTION

This invention relates to emergency evacuation equipment for aircraft. In particular, this invention relates to a device for inflating an inflatable aircraft emergency evacuation slide or other inflatable device.

The requirement for reliably evacuating airline passengers in the event of an emergency is well known. Emergencies at take-off and landing often demand swift removal of the passengers from the aircraft because of the potential from injuries from fire, explosion, or sinking in water. A conventional method of quickly evacuating a large number of passengers from an aircraft is to provide multiple emergency exits, each of which is equipped with an inflatable evacuation slide. Current state-of-the-art emergency evacuation slide systems comprise an inflatable evacuation slide which is stored in an uninflated, folded state together with a source of inflation gas. The source of inflation gas typically comprises a gas generator, stored compressed gas, or a combination thereof. Compressed stored gas inflators typically require the storage of a relatively large volume of gas at a relatively high pressure. As a result of high gas storage pressures, the walls of the storage vessel must be relatively thick for increased strength. The combination of large volume and thick walls results in relatively heavy and bulky inflator designs. Additionally, where only a compressed gas is used to inflate the evacuation slide, a large drop in temperature occurs as the compressed gas expands, often causing ice to form, which can block the flow of gas. Pyrotechnic gas generators have an advantage in that they are small, lightweight, and produce a high volume of gas. The high temperature gas produced by a gas generator alone, however, causes numerous problems including sagging of the evacuation slide as the inflation gas cools and, in some cases, melting or scorching of the fabric out of which the inflation slide is fabricated. Because of the disadvantages associated with pure stored gas and pure pyrotechnic inflation devices, current state of the art emergency evacuation slide systems typically comprise a hybrid inflator, which utilizes a stored compressed gas together with a pyrotechnic gas generator. The pyrotechnic gas generator augments the stored compressed gas by providing additional gas as well as heat to counteract the effects of the expansion-induced cooling of the compressed gas as it expands out of the pressure vessel. Despite these advances, convention hybrid evacuation slide inflators are still heavy and bulky. On one modem commercial aircraft, the weight of the pressure vessel alone is almost 35 pounds and weight of the gas charge over 16 pounds. Accordingly, the need still exists to further reduce the size and weight of emergency evacuation slide inflators and thereby improve the payload volume, weight, and fuel economy of the aircraft on which they are mounted.

### SUMMARY OF THE INVENTION

The present invention comprises an inflation device for an aircraft emergency evacuation slide or other inflatable device wherein the number moles of gas produced by the inflator is greater than the number of moles of gas stored. According to one embodiment of the present invention, this is accomplished by selecting the stored inflation gas to be one of a family of gases capable of undergoing a thermal decomposition. As used herein, a gas capable of undergoing a decomposition reaction refers to a gas the molecules of which may be disassociated from a single molecular species into two or more molecular species. “Thermal decomposition” is a decomposition reaction that is initiated and sustained by subjecting the gas to an elevated temperature.

In an illustrative embodiment, two moles of nitrous oxide are decomposed to form two moles of diatomic nitrogen and a mole of diatomic oxygen. Because the universal gas constant is the same for all gases, the three moles of nitrogen and oxygen produced by the decomposition of two moles of nitrous oxide occupy 50% more volume than the two moles of nitrous oxide would have occupied at the same temperature and pressure. Therefore, by decomposing the stored nitrous oxide, the illustrative evacuation slide inflator is capable of inflating an aircraft evacuation slide that is 50% larger than would be possible using undecomposed nitrous oxide. Since nitrous oxide has the same molecular weight was carbon dioxide (the most commonly used aircraft evacuation slide inflation gas), all else being equal, an aircraft evacuation slide inflator utilizing decomposing nitrous oxide will result in a weight savings of at least ⅓as compared with the weight of the inflation gas of a conventional carbon dioxide hybrid inflator.

### BRIEF DESCRIPTION OF THE DRAWING

The present invention will be better understood from a reading of the following detailed description, taken in conjunction with the accompanying drawing figures in which like references designate like elements and, in which:

FIG. 1 is a simplified, partially crossed sectioned plan view of an aircraft evacuation slide inflator incorporating principals of the present invention;

FIG. 2 is a simplified, partially crossed sectioned plan view of another alternative embodiment of an evacuation slide inflator incorporating features of the present invention.

FIG. 3 is a simplified, partially crossed sectioned plan view of yet another alternative embodiment of an evacuation slide inflator incorporating features of the present invention.

FIG. 4 is a simplified, partially crossed sectioned plan view of yet another alternative embodiment of an evacuation slide inflator incorporating features of the present invention.

FIG. 5 is a simplified, partially crossed sectioned plan view of an alternative embodiment of an evacuation slide inflator incorporating features of the present invention.

### DETAILED DESCRIPTION

The drawing figures are intended to illustrate the general manner of construction and are not necessarily to scale. In the detail description and the drawing figures, specific illustrative examples are shown and herein described in detailed. It should be understood, however, that the drawing figures and the drawing description are not intended to limit the invention to the particular form disclosed, but are merely illustrative and intended to teach one of ordinary skill how to make/use the invention claimed herein and for setting forth the best mode for carrying out the invention.

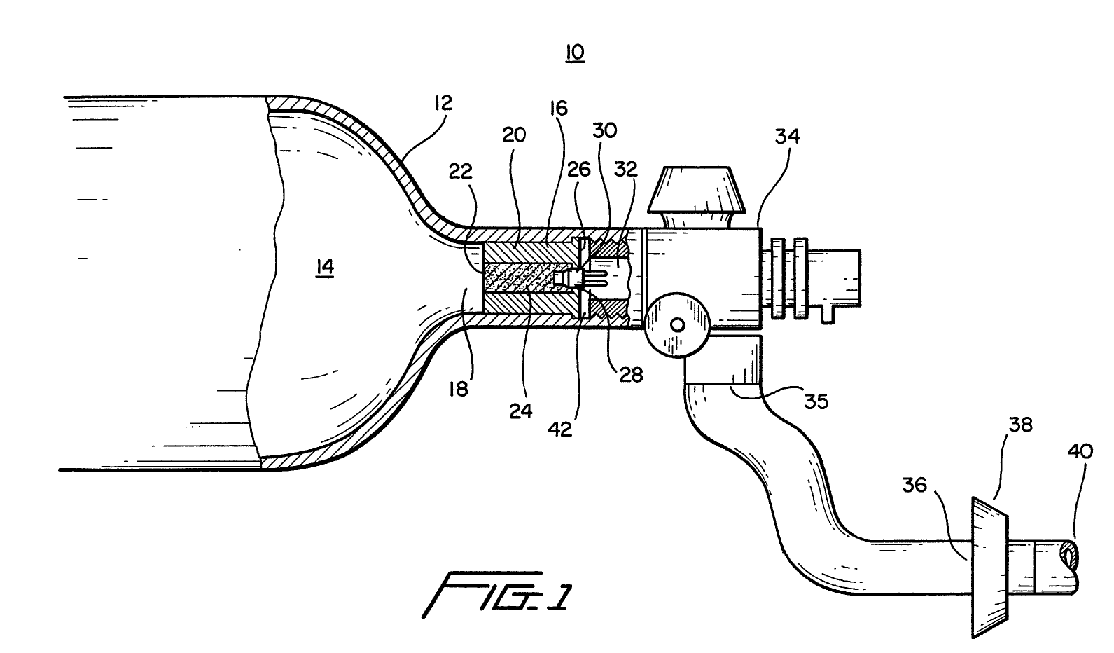

FIG. 1 is a simplified partially sectioned plan view of an aircraft emergency evacuation slide inflator 10. As will be described in greater detail below, the inflator 10 generates an inflation gas by decomposing a stored source gas material into at least two inflation gas species. The inflator 10 comprises a pressure vessel 12 containing a source gas mixture 14 that includes at least one gas source material that is capable of undergoing a thermal decomposition to form decomposition species used to inflate an associated aircraft evacuation slide or other inflatable device. A wide variety of gas source materials that undergo decomposition to form gaseous products are available. Such gas source materials include peroxide and peroxide derivatives such as methyl hyperoxide, and mixtures of methyl hyperoxide and methanol, hydrogen peroxide, alkyl hydroperoxides, propionyl and butyryl peroxide as well as mixtures thereof and nitrous oxide, (N₂O). Preferably the decomposable gas source material is nontoxic and noncorrosive in both the pre and post decomposition states; is relatively stable at ambient temperatures thus permitting and facilitating storage in a compressed gas or liquid phase; and liquefies at a relatively modest pressure at ambient temperatures.

In view of the manufacturability, storage and handling concerns, the preferred decomposable gas source material for use in practice of the present invention is nitrous oxide. In accordance with the chemical reactions (1) identified below, upon the decomposition of nitrous oxide, the decomposition products from one mole of nitrous oxide (N₂O) are two moles of diatomic nitrogen (N₂) and one mole of diatomic oxygen (O₂);

2N₂O=2N₂+O₂ (1)

Nitrous oxide, although classified as an oxidizer, in practice is generally nontoxic and noncorrosive and is relatively inert up to temperatures of about 200° C. Further, nitrous oxide, as compared to gases such as oxygen, nitrogen, and argon, liquefies relatively easily at ambient temperatures. Finally, nitrous oxide has the same molecular weight as carbon dioxide, which is the gas most commonly used in state of the art hybrid air bag inflators. Therefore, use of an equal amount of nitrous oxide entails no additional weight in inflation gas over conventional carbon dioxide inflators.

As used in the present invention the decomposable gas source material can be stored in a gaseous, liquid or multi-phase form (i.e., partially gaseous and partially liquid mixture). The premium on size generally placed on aircraft payload volume dictates a preference for smaller size evacuation slide inflators. Since the density of the gas source material is significantly greater in a liquid, rather than gaseous state, storage of source gas materials primarily in a liquid state will typically be preferred.

Pressure vessel 12 is closed by means of a reactor 16 placed in the area of the exit aperture 18 of pressure vessel 12. Reactor 16 comprises a housing 20 having a bore 22, which defines a gas channel though housing 20. Bore 22 is initially obstructed by means of a propellant mixture 24 filling the gas channel defined by bore 22. Housing 20 is preferably composed of ceramic or other material having high temperature stability and low thermal conductivity and which is resistant to attack by atomic oxygen at elevated temperatures. Pyrotechnic composition 24 may be any conventional propellant that combusts rapidly producing heat and gaseous combustion products with little or not particulates. Such energizers include cyclotrimethylene trinitramine (RDX); cyclotetramethylene tetranitramine (HMX); pentaerythritol tetranitrate (PETN), hexanitrohexaazaisowurtzitane (CL20), thermite, UPCO 7021 or similar energizers.

The base end 26 of housing 20 includes an opening 28 into which is inserted in a sealing relationship an initiator 30. It should be noted that to facilitate the sealing relationship between initiator 30 and pressure vessel 12, base end 28 may comprise a separate metal disk to which initiator 30 may be welded or crimped in order to provide a suitable hermetic seal. Initiator 30 may be of any suitable type including pyrotechnic, bridgewire, spark-discharge, exploding foil, or laser igniter, capable of producing sufficient heat input to initiate the combustion of pyrotechnic composition 24. A plenum 42 or other suitable undercut in the wall of pressure vessel 12 provides a suitable transition between bore 22 and inlet 32 of pressure regulator 34.

Pressure regulator 34 may be of a conventional design, such as a sliding spool regulator. Regulator 34 is adapted to regulate the pressure at inlet 32 down to a lower pressure at outlet 36 such that the gas pressure at inlet 36 of aspirator 38 is within the design pressure bandwidth for maximum efficiency of aspirator 38.

Aspirator 38 comprises a venturi (not shown). As compressed gas flows through inlet 36 of aspirator 38 the venturi produces a low pressure area that causes the aspirator to ingest about four times as much gas as is supplied by the inflator alone. This ingestion of air continues until the back pressure in aspirator outlet 40 exceeds a threshold pressure, indicating the inflatable device (not shown) is nearing full inflation, at which time the aspirator check valve or flapper doors close to prevent loss of inflation gas through the aspirator. Aspirators suitable use in the present invention include that disclosed in U.S. Pat. No. 4,368,009 to Heimovics, et al. the specification of which is incorporated herein by reference to the extent necessary to supplement this disclosure.

In operation, such as upon sensing the opening of an aircraft emergency evacuation door in the armed condition, an electrical signal is sent to the initiator 30. The initiator 30 functions and initiates combustion of the pyrotechnic composition 24. Pyrotechnic composition 24 heats housing 20 in the area of bore 22 to a temperature above the decomposition temperature for the stored nitrous oxide (about 1200° F./650° C.). Simultaneously, consumption of the initiator 30 and pyrotechnic composition 24 opens the gas channel defined by bore 22 to begin the flow of source gas mixture 14 into pressure regulator 34 and ultimately into the inflatable device. As the source gas mixture 14 flows through bore 22, however, the elevated temperature of housing 20 in the region of bore 22 causes the thermal decomposition of the nitrous oxide in the source gas mixture. Because the thermal disassociation of nitrous oxide is also exothermic the associated release of energy maintains the temperature of housing 20 in the region of bore 22 above the threshold temperature for the thermal decomposition of the nitrous oxide. Thus, the decomposition reaction is sustained for as long as the source gas mixture is flowing through housing 20 at a sufficient rate to compensate for the heat loss through housing 20.

As noted herein before, the thermal decomposition of nitrous oxide results in a 1.5:1 increase in the gas available for inflating the inflatable devices (2 moles of nitrous oxide being decomposed into a total of 3 moles of nitrogen and oxygen). Thus, an inflator in accordance with the present invention provides high inflation capacity with a minimum amount of stored gas. Additionally, by reacting the nitrous oxide source gas mixture only as it passes out of pressure vessel 12 the possibility of overpressurizing pressure vessel 12 by disassociating the nitrous oxide in the source gas mixture while it is still confined is minimized. Thus, pressure vessel 12 can be of lighter weight construction than would be necessary if, for example, the source gas mixture were decomposed while still in pressure vessel 12 as in certain prior art automobile airbag inflators.

In circumstances where the gas flow rate is sufficiently high and/or the thermal conductivity of housing 20 sufficiently low, it may be advantageous to include a diluent gas such as carbon dioxide to control the rate of heating of housing 20 and to insure that the decomposable constituent of the source gas mixture decomposes only as it is passing through housing 20 and not while still in pressure vessel 12. Carbon dioxide is a preferred diluent because it has a high thermal capacity (66 calories/gram latent heat of vaporization) and liquefies relatively easily at ambient temperatures and thus may be stored in a small volume. A mixture in the range of from 50/50 nitrous oxide/carbon dioxide to 20/80 nitrous oxide/carbon dioxide; preferably 40/60 nitrous oxide/carbon dioxide; and most preferably about 30% nitrous oxide and 70% carbon dioxide is preferred in the present invention as ratios in the range of 30% nitrous oxide 70% carbon dioxide will not reliably sustain the nitrous oxide decomposition outside the reactor 16 because of the heat absorbed by the carbon dioxide.

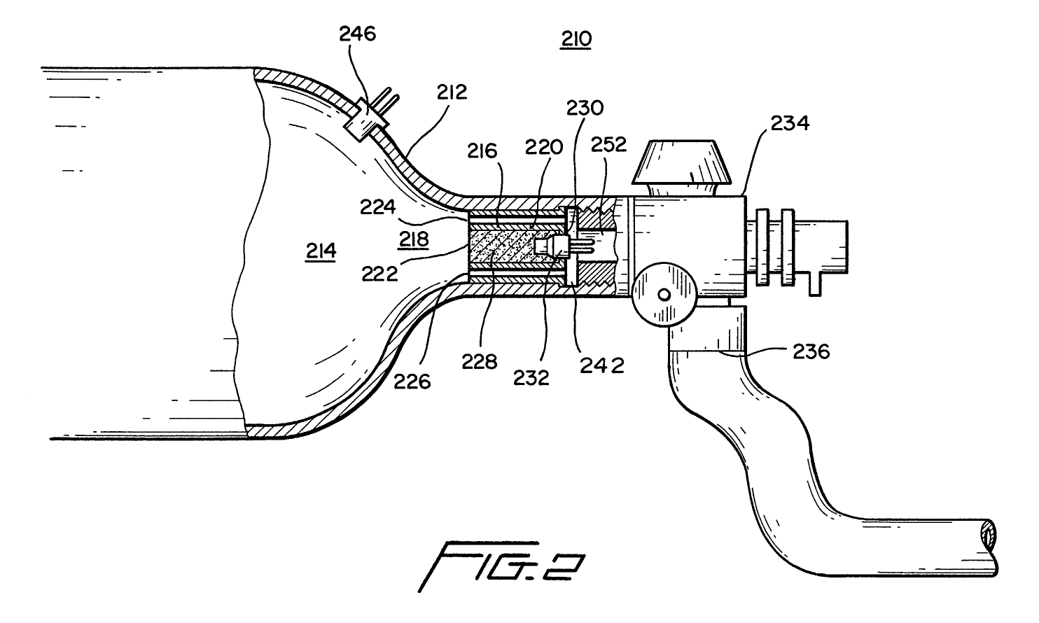

FIG. 2 depicts an alternative embodiment of an inflator 210 incorporating features of the present invention. Inflator 210 comprises a pressure vessel 212 containing a source gas mixture 214 which is capable of undergoing a thermal decomposition to form at least two separate gaseous species for filling an inflatable device. Pressure vessel 212 is closed by means of a reactor 216 composed of a suitable material having low thermal conductivity and high temperature strength, such as a ceramic, placed in the area of exit aperture 218. Reactor 216 comprises a central bore 222 and a plurality of peripheral bores 224 and 226 therethrough. Peripheral bores 224 and 226 are in fluid communication with plenum 242 leading to inlet 232 of regulator/valve 234.

As with the embodiment of FIG. 1, central bore 222 is initially obstructed by pyrotechnic composition 228 filling the gas channel defined by central bore 222. Base end 230 of reactor 216 includes an initiator 232 for initiating the combustion of pyrotechnic composition 228 in central bore 222 of reactor 216.

Because of the wide range of ambient temperatures over which aircraft emergency evacuation slides must operate (typically −65° F. to +165° F.) an inflator capable of producing enough disassociated nitrous oxide to fully inflate an evacuation slide at −65° F. will produce substantially more than enough gas to fully inflate the same aircraft slide at +165° F. In fact, the substantial excess gas may lead to over-pressurization of the evacuation slide. To prevent over-pressurization caused by the excess inflation gas, conventional designs must incorporate multiple pressure relief valves to vent the excess pressure, thereby adding extra weight to the evacuation slide system. Accordingly, to avoid the problems associated with potential high temperature over-pressurization of the evacuation slide, the embodiment of FIG. 2 is capable of delaying the onset of the gas disassociation, thereby reducing the total number of moles of gas produced for filling the inflatable device.

In operation, such as upon the sensing the opening of an aircraft emergency exit, an electrical signal is sent to regulator valve 234 which immediately begins the flow of source gas mixture 214 through outlet 236 to the aspirator (not shown) for ultimate inflation of the inflation device. A pressure transducer 246 senses when the pressure level inside pressure vessel 212 has dropped below a predetermined threshold. Upon sensing the reduced pressure in pressure vessel 212, pressure transducer 246 enables an electrical signal to reach initiator 232. Upon functioning of initiator 232, pyrotechnic composition 224 combusts and heats reactor 216 to a temperature above the decomposition temperature of the nitrous oxide constituent of the source gas mixture. Since the portion of the source gas mixture that has already passed through reactor 216 is undecomposed, the total gas output of inflator 210 is a mixture of nitrous oxide, nitrogen, oxygen and the carbon dioxide diluent rather than pure nitrogen, oxygen and diluent carbon dioxide as in the embodiment of FIG. 1. The total number of moles of gas, and therefore the total gas pressure produced by inflator 210 is reduced in proportion to the quantity of nitrous oxide that is unreacted. Thus, the embodiment of FIG. 2 includes the additional capability of controlling the total inflation pressure by regulating the total number of moles of gas used to inflate the inflatable device.

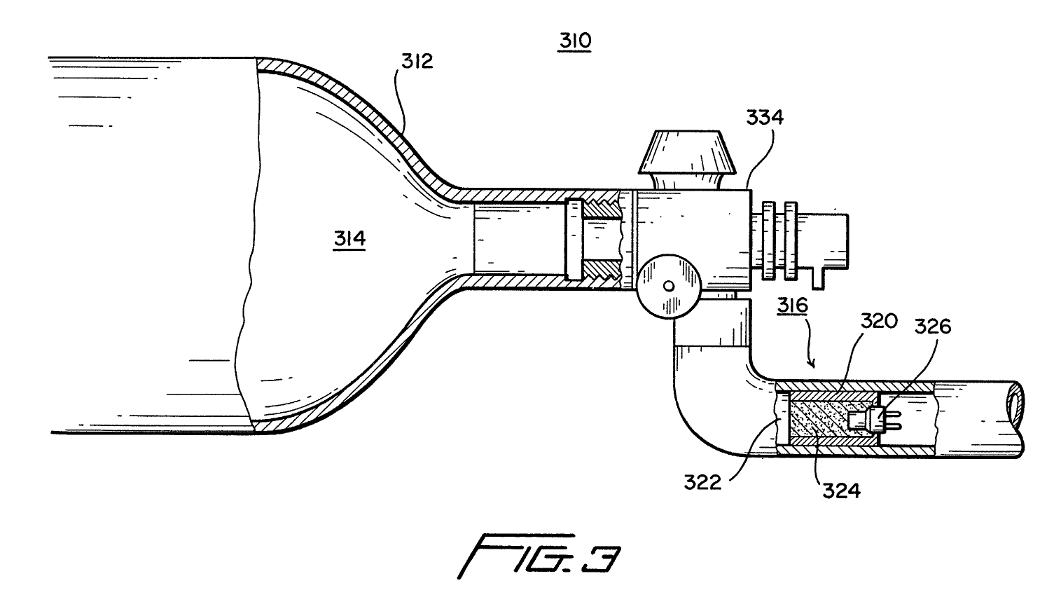

FIG. 3 depicts an additional alternative embodiment of inflator 310 incorporating features of the present invention. Inflator 310 comprises a pressure vessel 312 containing a source gas mixture 314 comprising at least one source gas material capable of undergoing thermal decomposition. Reactor 316, however, is located on the low pressure side of the regulator/valve 334. As with the embodiments of FIGS. 1 and 2, reactor 316 comprises a housing 320 composed of a suitable high temperature, low thermal conductivity material such as ceramic, which includes a central bore 322 and one or more peripheral bores (not shown) therethrough. A pyrotechnic composition 324 and an initiator 326 initially obstruct central bore 322.

In operation, such as upon sensing the opening of an emergency exit door, an electrical signal is sent to regulator valve 334 which begins the flow of source gas mixture 314. Simultaneously or after an appropriate delay, initiator 326 receives a signal. Upon functioning, initiator 326 ignites pyrotechnic composition 324, which heats reactor 316 to a temperature above the decomposition temperature of the nitrous oxide constituent of source gas material 314. Placing the reactor 316 on the low-pressure side of regulator/valve 334 facilitates control of the disassociation reaction. This is because the gas flow rate, and therefore the disassociation rate and heat input caused by the exothermic nature of the disassociation are occurring at relative steady state flow rates, as regulated by regulator valve 334.

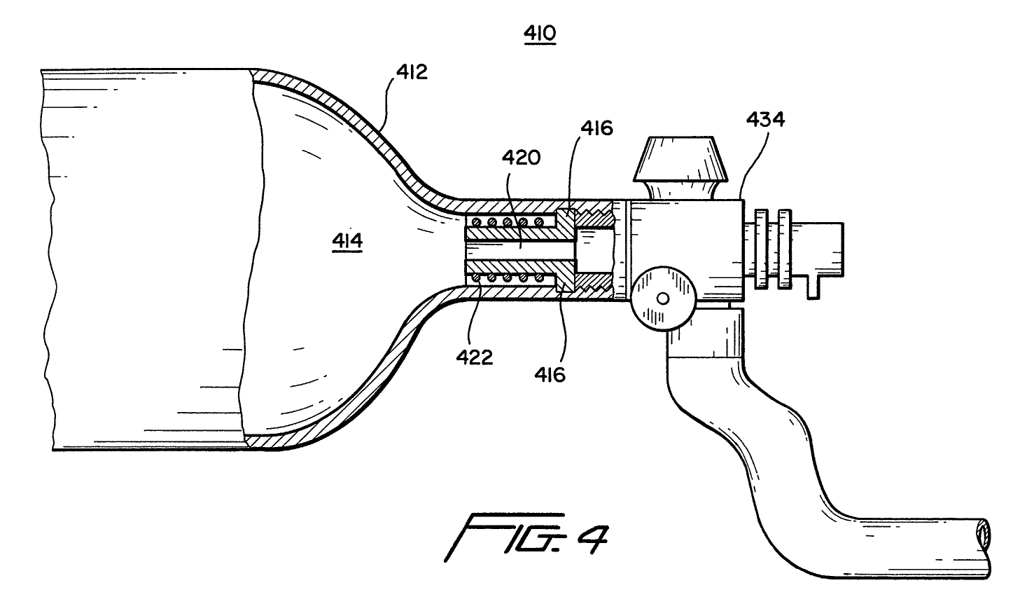

FIG. 4 depicts another alternative embodiment of an inflator 410 incorporating features of the present invention. Inflator 410 comprises a pressure vessel 412 having contained therein a source gas material 414 including a gas species capable of undergoing thermal decomposition to form two or more gaseous species for inflation of an inflatable device. A reactor 416 comprises a housing 418 made of a suitable material having a bore 420 therethrough. A series of inductive windings made of a suitable high conductivity material such as copper are wound around housing 418.

In operation, such as upon the sensing of an emergency exit door being opened, an electrical signal is sent to regulator/valve 434 which opens to begin the flow of source gas material to being inflation of the inflatable device. Simultaneously, or after a suitable delay, an alternating high amperage current is sent to windings 422 which cause inductive heating of housing 418 to a temperature above the disassociation temperature of the nitrous oxide constituent of source gas material 414. Depending on the ratio of carbon dioxide diluent to nitrous oxide, once initiated, the decomposition reaction may be self-sustaining due to the exothermic nature of the decomposition of nitrous oxide. Alternatively, the ratio of nitrous oxide to diluent may be chosen such that additional energy in the form of inductive heating from windings 422 are necessary to sustain the decomposition reaction. Thus, the embodiment of FIG. 4 is capable of starting and stopping the disassociation reaction, thus providing additional control over not only the total number of moles of gas produced but the inflation profile as well.

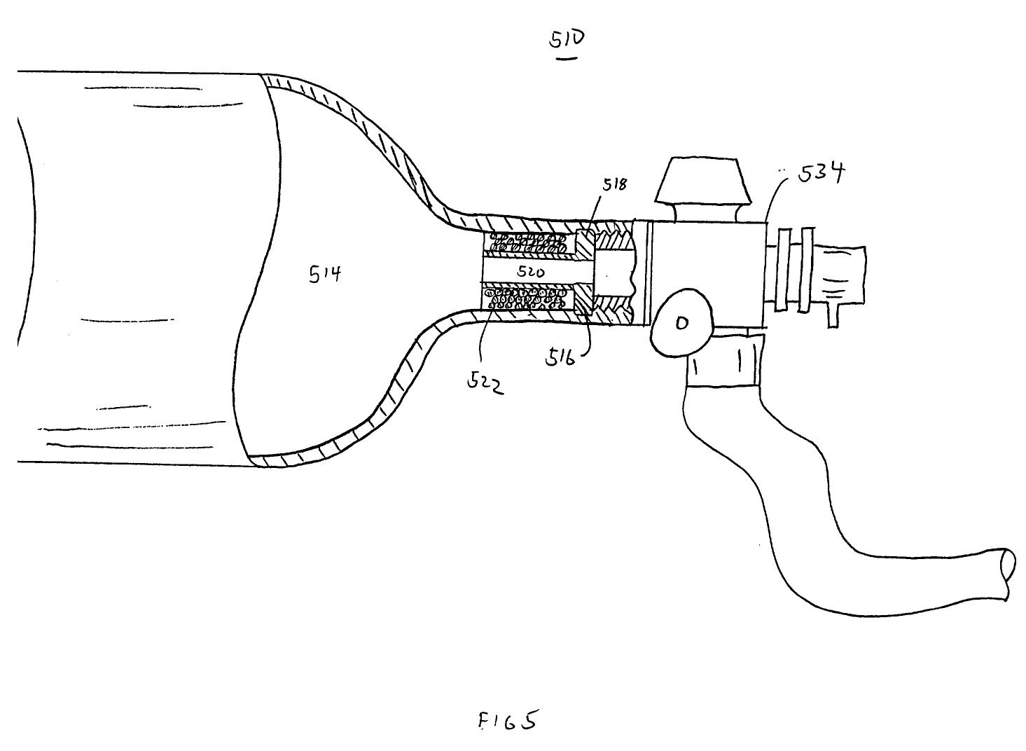

FIG. 5 depicts another alternative embodiment of an inflator 510 incorporating features of the present invention. Inflator 510 comprises a pressure vessel 512 having contained therein a source gas material 514 including a gas species capable of undergoing thermal decomposition to form two or more gaseous species for inflation of an inflatable device. A reactor 516 comprises a housing 518 made of a suitable material having a bore 520 therethrough. A series of resistance windings made of a suitable high resistance, high temperature material such as FeCrAlY are wound around housing 518.

In operation, such as upon the sensing of an emergency exit door being opened, an electrical signal is sent to regulator/valve 534 which opens to begin the flow of source gas material to being inflation of the inflatable device. Simultaneously, or after a suitable delay, a current is sent to windings 522 which heat housing 518 to a temperature above the disassociation temperature of the nitrous oxide constituent of source gas material 514. Depending on the ratio of carbon dioxide diluent to nitrous oxide, once initiated, the decomposition reaction may be self-sustaining due to the exothermic nature of the decomposition of nitrous oxide. Alternatively, the ratio of nitrous oxide to diluent may be chosen such that additional energy in the form of from windings 522 are necessary to sustain the decomposition reaction thus enabling the disassociation reaction to be started and stopped.

Although certain illustrative embodiments and methods have been disclosed herein, it will be apparent from the foregoing disclosure to those skilled in the art that variations and modifications of such embodiments and methods may be made without departing from the spirit and scope of the invention. Accordingly, it is intended that the invention shall be limited only to the extent required by the appended claims and the rules and principals of applicable law.

What is claimed is:

1. An apparatus for inflating an inflatable device comprising:
a pressure vessel
a source gas mixture comprising at least one gas source material and an inert diluent, said source gas mixture being stored under pressure in said pressure vessel, said gas source material comprising a fluid capable of undergoing an exothermic thermal decomposition to form decomposition products the number of moles of which are greater than the number of moles of said gas source material decomposed;
a pyrotechnic composition for heating said source gas mixture to a temperature at least equal to the minimum decomposition temperature of said gas source material such that at least a portion of said gas source material is caused to decompose upon initiation of said pyrotechnic composition;
a normally closed regulator valve disposed in a fluid path between said pressure vessel and said inflatable device, said regulator valve operable in a closed position to block a flow of gas from said pressure vessel to said inflatable device and operable in an open position to provide a regulated pressure flow of gas from said pressure vessel to said inflatable device; and
at least one aspirator disposed in said fluid path between said pressure vessel and said inflatable device, said aspirator operable to inject ambient air into said flow of gas from said pressure vessel to said inflatable device for augmenting said flow of gas into said inflatable device.

2. The apparatus of claim 1, wherein:
said diluent comprises an inert gas capable of absorbing heat, said source gas mixture having a ratio of gas source material to diluent below that at which said gas source material is capable of sustaining a decomposition reaction.

3. The apparatus of claim 2, further comprising
a reactor, said reactor comprising a first gas channel providing fluid communication between said pressure vessel and said inflatable device; and
wherein said pyrotechnic composition is located in said first gas channel and obstructing a gas flow therethrough, said pyrotechnic composition upon initiation combusting exothermically to unblock said first gas channel and to heat said first gas channel to a temperature at least equal to the minimum decomposition temperature of said gas source material, such that said source gas is caused to decompose as it flows through said reactor.

4. The apparatus of claim 3, wherein:
said gas source material is chosen from the group consisting of nitrous oxide, hydrogen peroxide, methyl hyperoxide, alkyl hyperoxide, propionyl peroxide and butyryl peroxide.

5. The apparatus of claim 3, wherein:
said reactor comprises a second gas channel providing fluid communication between said pressure vessel and said inflatable device that is not obstructed by said pyrotechnic composition, whereby said normally closed regulator valve is operable to permit a flow of undecomposed gas source
material to flow from said pressure vessel to said inflatable device through said second gas channel and said pyrotechnic composition is capable of thereafter being initiated to heat said first gas channel to cause a remaining portion of said gas source material to decompose as it passes through said reactor.

6. An apparatus for inflating an inflatable device comprising:
a pressure vessel
at least one gas source material stored under pressure in said pressure vessel, said gas source material comprising a fluid capable of undergoing a thermal decomposition to form decomposition products the number of moles of which are greater than the number of moles of said gas source material decomposed;
a reactor, said reactor comprising a first gas channel providing fluid communication between said pressure vessel and said inflatable device; and
means for heating said first gas channel to a temperature at least equal to the minimum decomposition temperature of said gas source material such that said gas source material is caused to decompose as it passes through said reactor.

7. The apparatus of claim 6, further comprising:
a normally closed regulator valve disposed in a fluid path between said pressure vessel and said inflatable device, said regulator valve operable in a closed position to block a flow of gas from said pressure vessel to said inflatable device and operable in an open position to provide a regulated pressure flow of gas from said pressure vessel to said inflatable device.

8. The apparatus of claim 7, wherein:
said reactor comprises a second gas channel providing fluid communication between said pressure vessel and said inflatable device.

9. The apparatus of claim 8, wherein:
said means for heating said first gas channel comprises a pyrotechnic composition disposed in said first gas channel and obstructing a gas flow therethrough, said pyrotechnic composition upon initiation being consumed exothermically to unblock said first gas channel and to heat said first gas channel to a temperature at least equal to the minimum decomposition temperature of said gas source material, whereby said normally closed regulator valve is operable to permit a flow of undecomposed gas source material to flow from said pressure vessel to said inflatable device through said second gas channel and said pyrotechnic composition thereafter being initiated to heat said first gas channel to cause a remaining portion of said gas source material to decompose as it passes through said reactor.

10. The apparatus of claim 7, further comprising:
an aspirator disposed in a fluid path between said normally closed regulator valve and said inflatable device, said aspirator operable to inject ambient air for augmenting an inflation gas flowing into said inflatable device.

11. The apparatus of claim 6, wherein:
said gas source material is chosen from the group consisting of nitrous oxide, hydrogen peroxide, methyl hyperoxide, alkyl hyperoxide, propionyl peroxide and butyryl peroxide.

12. The apparatus of claim 6, wherein:
said means for heating said first gas channel comprises an electric resistance heater.

13. The apparatus of claim 6, wherein:
said means for heating said first gas channel comprises an electric induction heater.

14. The apparatus of claim 6, wherein:
said means for heating said first gas channel comprises a pyrotechnic composition disposed in said first gas channel and obstructing a gas flow therethrough, said pyrotechnic composition upon initiation combusting exothermically to unblock said first gas channel and to heat said first gas channel to a temperature at least equal to the minimum decomposition temperature of said gas source material.

15. The apparatus of claim 6, further comprising:
at least one diluent gas mixed with said gas source material stored under pressure in said pressure vessel, said diluent gas acting to increase the thermal capacity of said gases stored in said pressure to prevent said gas source material from decomposing within said pressure vessel.

16. Apparatus for inflating an inflatable device comprising
a pressure vessel
at least one gas source material stored under pressure in said pressure vessel, said gas source material comprising a fluid capable of undergoing a thermal decomposition to form decomposition products the number of moles of which are greater than the number of moles of said gas source material decomposed;
a reactor, said reactor comprising a ceramic housing defining a first gas channel, said first gas channel providing fluid communication between said pressure vessel and said inflatable device; and
a pyrotechnic composition obstructing said first gas channel preventing a flow of gas therethrough, such that upon initiation of said pyrotechnic composition, said pyrotechnic composition is consumed exothermically to unblock said first gas channel and to heat said first gas channel to a temperature at least equal to the minimum decomposition temperature of said gas source material.

17. The apparatus of claim 16 further comprising:
a normally closed regulator valve disposed in a fluid path between said pressure vessel and said inflatable device, said regulator valve operable in a closed position to block a flow of gas from said pressure vessel to said inflatable device and operable in an open position to provide a regulated pressure flow of gas from said pressure vessel to said inflatable device, and wherein said reactor further comprises a second gas channel, said second gas channel providing a gas flow path between said pressure vessel and said inflatable device, whereby said normally closed regulator valve is operable to permit a flow of undecomposed gas source material to flow from said pressure vessel to said inflatable device through said second gas channel and said pyrotechnic composition is capable of being thereafter initiated to heat said first gas channel to cause a remaining portion of said gas source material to decompose as it passes through said reactor.

18. The apparatus of claim 16, wherein:
said gas source material is chosen from the group consisting of nitrous oxide, hydrogen peroxide, methyl hyperoxide, alkyl hyperoxide, propionyl peroxide and butyryl peroxide.
